(19) United States
(12) Patent Application Publication
(10) Pub. No.: US 2003/0038003 A1
(43) Pub. Date: Feb. 27, 2003

(54) Vehicle drum brake

(76) Inventor: Jae-Wan Jin, Kyungki-Do (KR)

Correspondence Address: Pennie & Edmonds, LLP, 3300 Hillview Avenue, Palo Alto, CA, 94304, US

(21) Appl. No.: 10/224,072

(22) Filed: Aug. 19, 2002

(30) Foreign Application Priority Data
Aug. 21, 2001 (KR) 2001-50347

(51) Int. Cl. F16D 51/00

(52) U.S. Cl. 188/330; 188/329; 188/332

(57) ABSTRACT

The invention relates to a vehicle drum brake including a wheel cylinder including two pistons and lever device installed at the wheel cylinder to be rotated by a parking cable to linearly move the two pistons of the wheel cylinder apart. The present invention compacts the parts of the drum brake relevant to the mechanism for braking a running or parking vehicle and prevents noise generated between the separately constructed manipulating lever and brake shoes, when they are in contact.

### FIELD OF THE INVENTION

The present invention relates to a vehicle drum brake, and more particularly to a vehicle drum brake integrated with a wheel cylinder and operating lever to thereby improve braking force and reduce operational noise when the vehicle is parked.

### BACKGROUND OF THE INVENTION

In general, a vehicle equipped with drum brakes is stopped when the driver steps on the brake pedal, causing brake fluid from the master cylinder to flow to the individual wheel cylinders. Pistons of the wheel cylinders are thereby extended, forcing the brake shoes and pads or liners against the drum. Such drum brakes are also typically equipped with a parking brake mechanism actuated by a parking brake lever or separate pedal.

In the typical system, when the parking brake lever or pedal is manipulated to park a vehicle, a parking brake cable pulls a manipulating lever within the drum brake. The manipulating lever is coupled directly to the brake shoes.

When the manipulating lever is operated via the cable, the manipulating lever acts directly on one shoe and a strut coupled with the manipulating lever pushes the opposite shoe against the brake drum. However, such conventional drum brakes require relatively many parts and much space to accommodate the operating mechanisms for both regular and parking braking. In addition, such conventional parking brake mechanisms generate excessive noise due to contact between the manipulating lever, and the leading shoe.

### SUMMARY OF THE INVENTION

According to the present invention, there is provided a vehicle drum brake comprising a wheel cylinder including two pistons and lever means installed at the wheel cylinder to be rotated by force applied through a parking cable to linearly move the two pistons of the wheel cylinder apart. The lever means comprises a pressing member installed between the two pistons in a body of the wheel cylinder for pressing the two pistons so that the two pistons move apart from each other. A lever shaft extends outside the wheel cylinder to function as a rotational axis of the pressing member. A lever member connects the lever shaft and the parking cable to transform the force applied through the parking cable into rotational a moment of the lever shaft.

In an alternative preferred embodiment of the present invention, brake shoes are pivotably mounted on a back plate. A wheel cylinder is disposed between the brake shoes. Opposed pistons are disposed in the wheel cylinder, one each acting on a brake shoe. A pressing member is disposed within the cylinder and acting on the pistons. The pressing member preferably cooperates with a vehicle parking brake and is rotatable to expand the pistons separately from fluid in the cylinder in response to actuation of the parking brake. The pressing member is preferably mounted on a shaft extending out of the wheel cylinder. A lever is mounted on the shaft opposite the pressing member and is preferably adapted to be secured to a parking brake actuating cable. A roller is preferably mounted on the pressing member for bearing against the pistons.

### BRIEF DESCRIPTION OF THE DRAWINGS

For fuller understanding of the nature and object of the invention, reference should be made to the following detailed description taken in conjunction with the accompanying drawings in which:

FIG. 1 is an exploded perspective view illustrating a drum brake;

FIG. 2 is an exploded perspective view illustrating a wheel cylinder and lever means in accordance with the present invention; and

FIGS. 3 and 4 are views illustrating the assembled and operating states of a wheel cylinder according to an embodiment of the present invention.

### DETAILED DESCRIPTION OF THE INVENTION

Hereinafter, the preferred embodiments of the present invention will be described in detail with reference to the accompanying drawings.

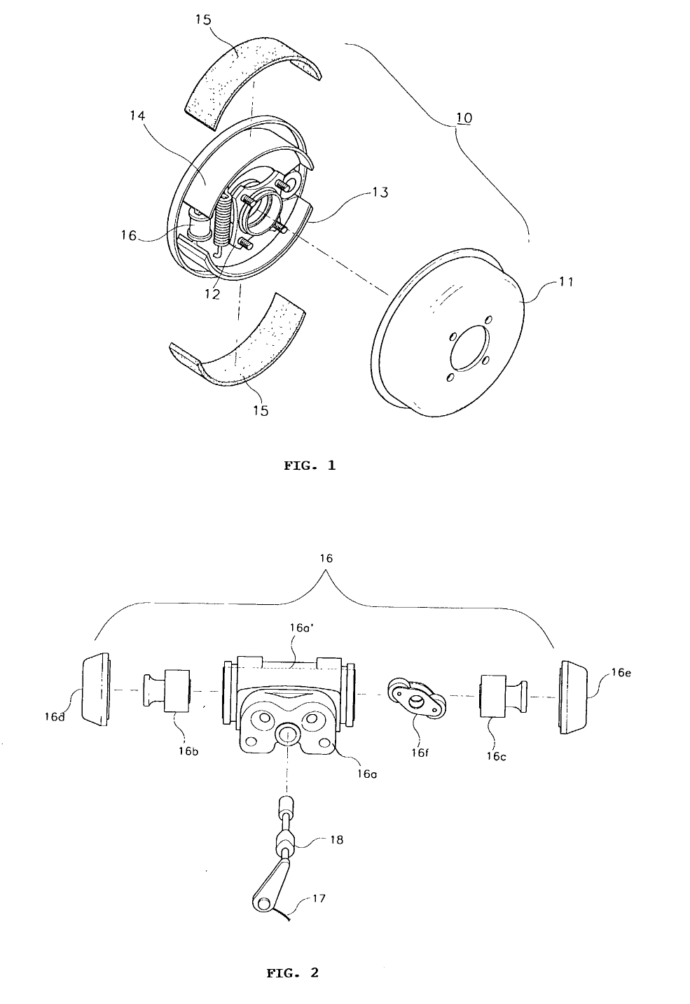

A vehicle drum brake, as shown in FIG. 1, includes a brake drum 11 installed at a wheel hub via bolts for simultaneous rotation with the wheel. A back plate 12 is fixed to the vehicle axis. An iron leading shoe 13 and trailing shoe 14 are installed in front of the back plate 12. A frictional lining 15 is attached to an external surface of the shoes 13, 14, for stopping the rotation of the brake drum 11 by direct contact with the brake drum 11. A wheel cylinder 16 presses the shoes 13, 14 against the brake drum 11 via oil pressure generated from a master cylinder.

In a preferred embodiment of the present invention, wheel cylinder 16, as shown in FIG. 2, includes a shaft hole 20 formed in a wheel cylinder body 16a. Lever means as described below is installed through the shaft hole 20. Pistons 16b and 16c are slideably disposed in cylinder body 16a, with pressing member 22a interposed between the pistons. Piston boots 16d and 16eare provided over the pistons to seal the wheel cylinder body.

The lever means comprises pressing member 22a, which is disposed between the two pistons 16b, 16c of the wheel cylinder body 16a. The pressing member 22a is installed at a predetermined angle relative to a straight line connecting to the two pistons 16b, 6c and rotated to press on the two pistons 16b, 16c so that the two pistons move apart. A lever shaft 22b is supported through the shaft hole 20 of the wheel cylinder 16 and forms the rotational axis of the pressing member 22a. A lever member 22c connects the lever shaft 22b and the parking cable 17 to transform the tensile stress of the parking cable 17 into a rotational moment of the lever shaft 22b. The lever means is rotated by force applied through parking cable 17 to linearly move pistons 16b, 16c of the wheel cylinder 16 apart, so that the shoes 13, 14 are pressed against the brake drum. Pressing member 22a preferably includes roll-contacting members at both sides to make smooth contact with the pistons 16b, 16c to prevent excessive wear or noise.

The operational procedure to brake a running vehicle is the same as that of a conventional drum brake. In other words, if a driver steps on a brake pedal, the oil pressure generated at the master cylinder is supplied to the wheel cylinder. Then the two pistons 16b, 16c press the shoes 13, 14 toward the brake drum to provide braking force. The pressing member 22a and the lever means of the present invention have no effect on the oil pressure supplied to the wheel cylinder in this operation.

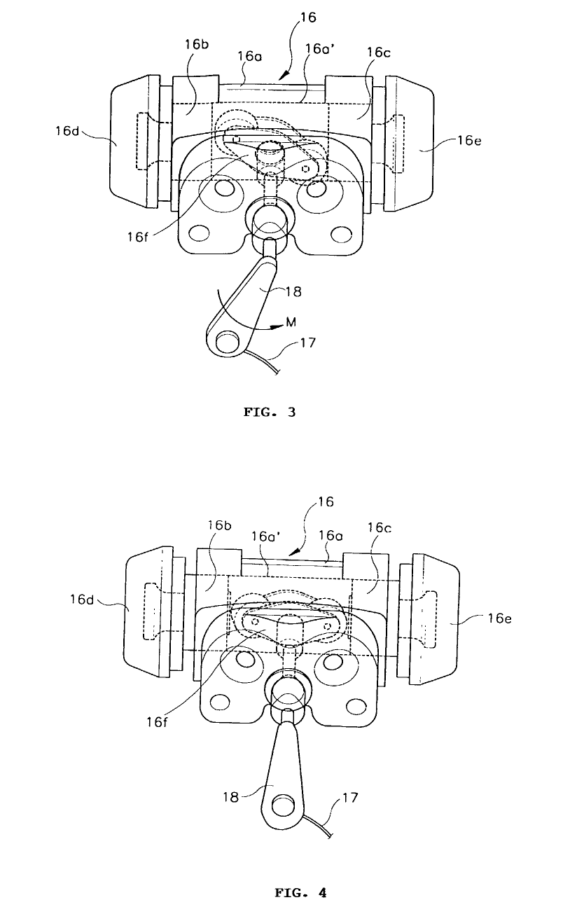

When the driver parks using the parking brake, as shown in FIGS. 3 and 4, the parking cable 17 connected with the parking brake is pulled to rotate the lever shaft 22b. Accordingly, the pressing member 22a rotates against the two pistons 16b, 16c and forces them outward. As a result, the two pistons 16b, 16c press the shoes against the brake drum to obtain a braking force without any oil supply from the master cylinder.

When the driver manipulates the parking brake to remove force from the parking cable, the rotating force is no longer applied to the pressing member. The pressing force is thus no longer applied to the pistons and it is possible to release all the braked states.

As described above, there are advantages in the present invention in that it is possible to compact the structure of the parts relating to the mechanism to brake a running or parking vehicle with a drum brake, thereby preventing noise generated between the separately constructed manipulating lever and brake shoes, when they are in contact, and reducing the space and the number of parts.

What is claimed is:

1. A vehicle drum brake comprising:
a wheel cylinder including two pistons; and
lever means installed at the wheel cylinder to be rotated by force applied through a parking cable to linearly move the two pistons of the wheel cylinder apart.

2. The drum brake, as defined in claim 1, wherein the lever means comprises:
a pressing member installed between the two pistons in a body of the wheel cylinder for pressing on the two pistons;
a lever shaft extending outside the wheel cylinder to function as a rotational axis of the pressing member; and
a lever member for connecting the lever shaft and the parking cable to transform force from the parking cable into rotation of the lever shaft.

3. The drum brake, as defined in claim 2, wherein the pressing member comprises roll-contacting members at both sides thereof to smoothly contact the two pistons.

4. The drum brake, a defined in claim 3, wherein the roll-contacting members are rollers.

5. A vehicle drum brake, comprising:
brake shoes pivotably mounted on a back plate;
a wheel cylinder disposed between said shoes;
opposed pistons disposed in said wheel cylinder, one each acting on a brake shoe;
a pressing member disposed within said cylinder and acting on said pistons, said pressing member cooperating with a vehicle parking brake and being rotatable to expand said pistons separately from fluid in the cylinder in response to actuation of the parking brake.

6. The drum brake of claim 5, wherein said pressing member is mounted on a shaft extending out of said wheel cylinder.

7. The drum brake of claim 6, further comprising a lever mounted on said shaft opposite the pressing member, said lever adapted to be secured to a parking brake actuating cable.

8. The drum brake of claim 5, further comprising a roller mounted on the pressing member for bearing against said pistons.
